(19) United States
(12) Patent Application Publication
(10) Pub. No.: US 2024/0013433 A1
(43) Pub. Date: Jan. 11, 2024

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventor: Ryosuke MIZUNO, Chiba (JP)

(21) Appl. No.: 18/338,536

(22) Filed: Jun. 21, 2023

(30) Foreign Application Priority Data
Jul. 7, 2022 (JP) 2022-109518

(51) Int. Cl. G06T 7/73; G06V 10/74

(52) U.S. Cl. CPC G06T 7/73; G06V 10/761

(57) ABSTRACT

An information processing device capable of reducing errors when estimating the position/posture of a moving apparatus comprises a detection information acquisition unit configured to acquire detection information detected by a sensor on a moving apparatus, a similarity calculation unit configured to calculate similarities of a plurality of pieces of detection information acquired by the detection information acquisition unit at different positions or different orientations, an additional object determination unit configured to determine positions of additional objects to be added within a detection range of the sensor when the detection information is detected, based on the similarities calculated by the similarity calculation unit, and a notification unit configured to give a notification of the positions of the additional objects determined by the additional object determination unit.

### BACKGROUND OF THE INVENTION

### Field of the Invention

The present invention relates to an information processing device, an information processing method, a storage medium, and the like that are suitable for estimating the position/posture of a moving apparatus.

### Description of the Related Art

A method of mounting a camera and a sensor such as a distance sensor on a moving apparatus and estimating the position/posture of the moving apparatus based on information acquired by the camera and the sensor is known. As the method, for example, simultaneous localization and mapping (SLAM) technology is known.

Examples of a moving apparatus include an automatic guides vehicle (AGV), an autonomous mobile robot (AMR), a small mobility such as a cleaning robot, a drone, and the like.

SLAM concurrently performs processing for generating a three-dimensional environment map and self-position/posture estimation processing using the environment map. In Document 1 (M. A. RAUL, J. M. M. MONTIEL AND J. D. TARDOS., “ORB-SLAM: A VERSATILE AND ACCURATE MONOCULAR SLAM SYSTEM” TRANS. ROBOTICS VOL. 31, 2015), processing called relocalization is performed as a method of recovering self-position/posture estimation after the self-position/posture estimation has not been successful.

In relocalization, in order to estimate the current self-position/posture, map elements including information similar to information (for example, images) acquired by a sensor at the current position/posture are searched for from a three-dimensional environment map.

However, in the method disclosed in Document 1, when there are a plurality of similar map elements, there is a possibility that the accuracy of a relocalization result will be lowered due to an error when estimating the position/posture of a moving apparatus.

### SUMMARY OF THE INVENTION

An information processing device according to one aspect of the present invention includes at least one processor or circuit configured to function as: a detection information acquisition unit configured to acquire detection information detected by a sensor on a moving apparatus; a similarity calculation unit configured to calculate similarities of a plurality of pieces of detection information acquired by the detection information acquisition unit at different positions or different orientations; an additional object determination unit configured to determine positions of additional objects to be added within a detection range of the sensor when the detection information is detected, based on the similarities calculated by the similarity calculation unit; and a notification unit configured to give a notification of the positions of the additional objects determined by the additional object determination unit.

Further features of the present invention will become apparent from the following description of embodiments with reference to the attached drawings.

### BRIEF DESCRIPTION OF THE DRAWINGS

FIG. 1 is a functional block diagram illustrating a configuration example of an information processing device according to a first embodiment of the present invention.

FIG. 2 is a hardware block diagram of an information processing device according to the first embodiment.

FIG. 3 is a flowchart showing a flow of the entire processing of the information processing device according to the first embodiment.

FIG. 4 is a diagram illustrating an example of an object information list to be added to an environment according to the first embodiment.

FIG. 5 is a diagram illustrating an example of an additional object notification method according to the first embodiment.

FIG. 6 is a diagram illustrating a configuration of an information processing device in another embodiment.

### DESCRIPTION OF THE EMBODIMENTS

Hereinafter, with reference to the accompanying drawings, favorable modes of the present invention will be described using embodiments. In each diagram, the same reference signs are applied to the same members or elements, and duplicate description will be omitted or simplified.

### First Embodiment

In a first embodiment, an example of a moving apparatus that acquires detection information such as an image detected by a sensor such as a camera mounted on the moving apparatus and automatically travels (autonomously travels) by SLAM by using the detection information will be described. Note that the sensor may be a distance measurement unit such as LIDAR that outputs distance information as the detection information, as will be described later.

Further, in the present embodiment, regarding a plurality of pieces of detection information such as images constituting a map element, it is determined whether similarities of a plurality of pieces of detection information detected at different positions or orientations are equal to or greater than a predetermined threshold value. In addition, when there is detected information with a similarity equal to or higher than the predetermined threshold value, the position, pattern, and posture of an object to be added within a detection range (within a field of view) of a sensor such as a camera are determined in order to lower the similarity.

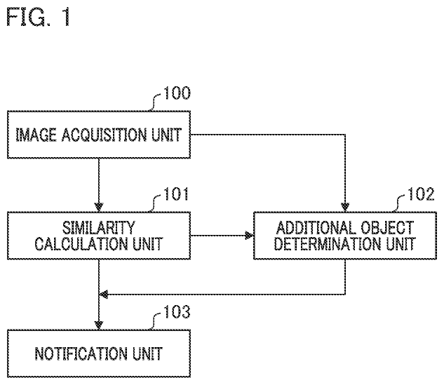

FIG. 1 is a functional block diagram illustrating a configuration example of the information processing device according to the first embodiment of the present invention. Note that some of the functional blocks illustrated in FIG. 1 are realized by causing a computer included in the information processing device to execute a computer program stored in a memory as a storage medium.

However, some or all of them may be realized by hardware. As the hardware, a dedicated circuit (ASIC), a processor (reconfigurable processor, DSP), or the like can be used.

In addition, each of the functional blocks illustrated in FIG. 1 may not be built into the same housing, and may be constituted by separate devices connected to each other via signal paths.

Reference numeral 100 denotes an image acquisition unit that acquires a plurality of images captured by an imaging device as an imaging unit mounted on a moving apparatus that moves in a predetermined region. Here, the image acquisition unit 100 (detection information acquisition unit) acquires detection information such as an image detected by an imaging device as a sensor mounted on the moving apparatus.

Note that, in the present embodiment, a keyframe in which an image stored in a storage device and the position/posture of the imaging device when the image is captured are associated with each other is acquired. Note that, in the present embodiment, the keyframe is an image of a structure, a building, a signboard, a sign, or the like that serves as a mark for specifying the location thereof, and is an image acquired by the imaging device mounted on the moving apparatus.

Reference numeral 101 denotes a similarity calculation unit that calculates a similarity between a plurality of images acquired by the image acquisition unit 100. Here, the similarity calculation unit 101 calculates similarities of a plurality of pieces of detection information detected at different positions or orientations, the detection information being acquired by the image acquisition unit 100 as a detection information acquisition unit.

Reference numeral 102 denotes an additional object determination unit that determines the pattern and the position/posture of an object to be added to a field of view corresponding to a plurality of image groups acquired by the image acquisition unit 100 based on the similarities calculated by the similarity calculation unit 101.

Based on the similarities calculated by the similarity calculation unit 101, the additional object determination unit 102 determines an additional object to be added within a detection range of the sensor (within a field of view of the camera) when the detection information is detected. Note that, in the present embodiment, the additional object determination unit 102 determines not only the position of the additional object but also at least one of the posture and pattern of the additional object.

Reference numeral 103 denotes a notification unit that notifies information determined by the additional object determination unit 102. The notification unit 103 notifies the user of at least the position of the additional object determined by the additional object determination unit 102.

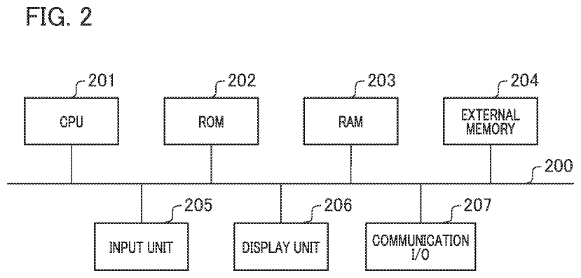

FIG. 2 is a hardware block diagram of the information processing device according to the first embodiment. Reference numeral 200 denotes a bus that connects various devices, reference numeral 201 denotes a CPU as a computer which controls the various devices connected to the bus 200 and reads and executes processing steps and programs, and reference numeral 202 denotes a ROM that stores BIOS programs and boot programs.

Reference numeral 203 denotes a RAM used as a main storage device of the CPU 201, reference numeral 204 denotes an external memory that stores computer programs processed by the CPU 201, and reference numeral 205 denotes an input unit that performs processing related to an input of information or the like. Reference numeral 206 denotes a display unit that outputs results of the information processing device to a display device according to an instruction from the CPU 201. Reference numeral 207 denotes a communication I/O unit that performs information communication via a network.

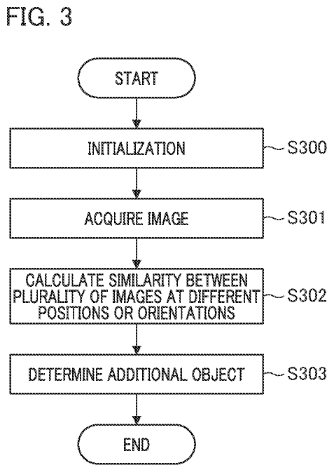

FIG. 3 is a flowchart showing a flow of the overall processing of the information processing device according to the first embodiment. Note that the CPU 201 as a computer executes a computer program stored in, for example, the external memory 204 to perform operations of steps in the flowchart of FIG. 3. Further, the flow of FIG. 3 is processing that is repeatedly performed while the moving apparatus moves to a target point.

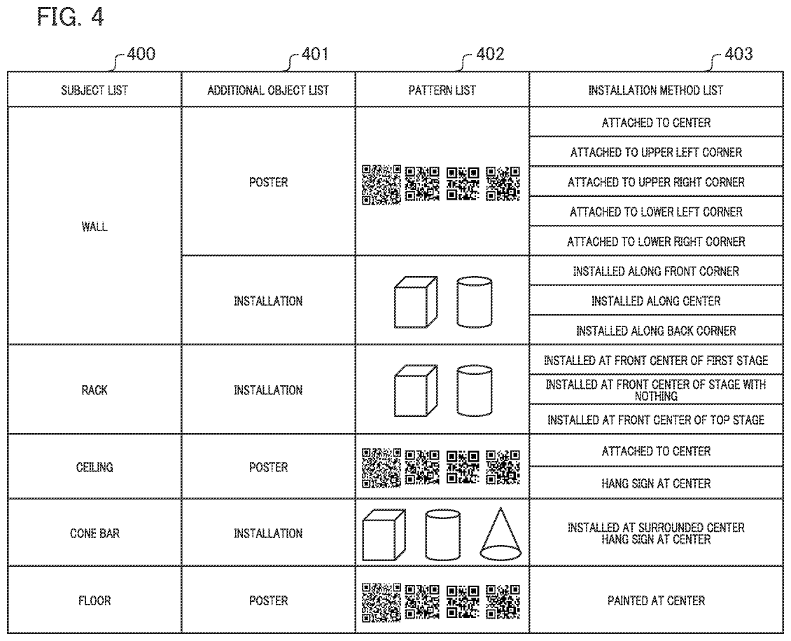

In step S300, the CPU 201 initializes the information processing device. That is, the computer program is read from the external memory 204 and is made executable. In addition, information necessary for processing, for example, a similarity threshold value used when the additional object determination unit 102 determines whether a plurality of image groups are similar, and an information list of additional objects illustrated in FIG. 4 are read to the RAM 203. The information list of the additional objects in FIG. 4 will be described later.

In step S301 (detection information acquisition step), the CPU 201 causes the image acquisition unit 100 to acquire a plurality of image groups (key frames) at different positions or orientations. That is, in step S301, an image is acquired as detection information output from the imaging device as the sensor mounted on the moving apparatus.

Then, in step S302 (similarity calculation step), the CPU 201 causes the similarity calculation unit 101 to calculate a similarity R between the plurality of images captured at different positions or orientations and acquired in step S301. That is, in step S302, a similarity between the images as a plurality of pieces of detection information detected at the different positions or orientations and acquired in step S301 as the detection information acquisition step, is calculated.

A well-known technique based on Bag of Words (BOW) is applied to calculate the similarity R between the plurality of images. Specifically, feature vectors are extracted from the images, and a similarity of the feature vectors is calculated as a similarity between the images. The similarities of the feature vectors are set to be an inner product of the vectors. Note that details of BOW are also disclosed in, for example, Document 1.

In step S303 (additional object determination step), the CPU 201 causes the additional object determination unit 102 to determine the pattern and the position/posture of an object to be added to the field of view (environment) of the camera corresponding to the plurality of image groups acquired in step S301.

That is, in step S303, the position of an object to be added within a detection range (within a field of view) of the sensor (hereinafter abbreviated as an additional object) when the images are detected as detection information is determined based on the similarities calculated in step S302 as the similarity calculation step. A method of determining additional objects will be described later.

Note that a user is notified of the position and the like of the additional object determined in step S303 as the additional object determination step in a notification step, which is not illustrated in the drawing, after step S303. Thereby, the user installs (pasting, painting, and the like) the additional object having a pattern notified in step S303 at the determined position/posture, and thus it is possible to reduce a position/posture estimation error and an error in relocalization.

FIG. 4 is a diagram illustrating an example of an information list of additional objects according to the first embodiment, and illustrates an example of an object information list used when determining the pattern and the position/posture of an additional object in step S303.

In FIG. 4, reference numeral 400 denotes a subject list that may be present in the image group acquired in step S301, and reference numeral 401 is an additional object list related to additional objects associated (linked) with the subject list 400.

Reference numeral 402 denotes a pattern list of additional objects associated (linked) with the additional object list 401. Reference numeral 403 denotes an installation method list for additional objects which is associated (linked) with the subject list 400 and the additional object list 401. Here, the installation method indicates a positional relationship and method when an additional object is installed for a subject listed in the subject list 400.

Next, in the additional object determination method performed in step S303 in the first embodiment, for each similar image group, the pattern and the position/posture of an object are determined such that a similarity between a plurality of images in the group is set to be less than a similarity threshold value.

A similar image group is created by sorting images in accordance with whether images are similar to a specific image. Specifically, similarities (R12, R13, . . . , R1i) of all images (I2, I3, . . . , Ii) except for a specific image I1 stored in the storage device and acquired in step S301 are calculated, for example, with the image I1 as a reference.

In addition, from among them, images having the above-mentioned similarity threshold value or more are set as a similar image group G1 as similar images. Next, the same processing is performed on all images that do not belong to the similar image group with another specific image different from the image I1 as a reference, thereby creating similar image groups (G1, G2, . . . , GI) for all images. In addition, an image in which there is no image having a similarity equal to or higher than the threshold value is set as a non-similar image group GN.

The images belonging to the similar image group are determined based on a subject (imaged object) of each image so that patterns of the additional objects are necessarily different from each other in the same image group, and the pattern and the position/posture of an object are not determined for an image belonging to the non-similar image group.

A method of determining an additional object in each image is, for example, as follows. That is, a subject shown in the image is detected by an image recognition method using a trained model such as a convolutional neural network (CNN).

In addition, among the detected subjects, a subject that is present in the subject list 400 and has the highest pattern matching score in image recognition is extracted. Then, an additional object is determined from the additional object list 401 associated (linked) with the subject.

Regarding the pattern of the additional object in each image, patterns described in the pattern list 402 associated with the additional object are determined in order so that they do not overlap each other within the same similar image group. At this time, when there are no objects that do not overlap each other among the objects listed in the pattern list, the pattern of the additional object which is processed using rotation and scaling is set as the pattern of the additional object.

Regarding the position/posture of the additional object in each image, installation methods described in the installation method list 403 associated with the additional object are selected in order, and the position/posture of the object based on the coordinates in the image are determined based on the selected installation method.

After the pattern and the position/posture of the above-mentioned additional object are determined for all images in the similar image group, determination of the pattern and the position/posture of an object is repeated until a similarity between images is set to be less than a similarity threshold value when the object is present within a field of view (environment) of a camera.

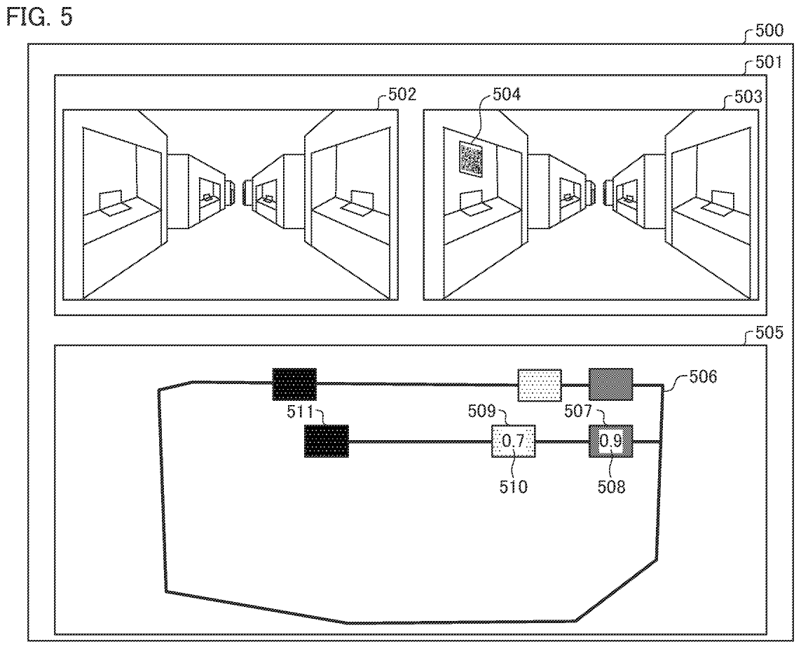

For the similarity between the images at this time, the similarity calculation method used in step S302 is used. An example of a method of giving a notification of notification contents of the notification unit 103 using a graphical user interface (GUI) will be described with reference to FIG. 5.

FIG. 5 is a diagram illustrating an example of an additional object notification method according to the first embodiment. Reference numeral 500 denotes an image display screen of a terminal operated by a user, and reference numeral 501 denotes an image display unit that displays a plurality of images captured at different positions or orientations and acquired in step S301. Reference numeral 502 denotes a reference image display unit that displays a reference image, which is a first type of image among the plurality of images captured at the different positions or orientations and acquired in step S301.

Reference numeral 503 denotes a reference image display unit that displays a reference image, which is a second type of image among the plurality of images captured at the different positions or orientations and acquired in step S301, and reference numeral 504 denotes CG of an additional object which is determined and notified in step S303. Reference numeral 505 denotes an environment map display unit that displays an environment map (SLAM map), and reference numeral 506 displays a route by connecting the positions/postures of the imaging device that captures the images acquired in step S301.

Reference numeral 507 denotes a first mark indicating the position/posture of the imaging device that captures an image when the pattern and the position/posture of the additional object are first determined in step S303. Reference numeral 508 denotes a first similarity that represents the similarity of the plurality of images calculated in step S302 and referred to when the pattern and the position/posture of the additional object are first determined in step S303.

Reference numeral 509 denotes a second mark indicating the position/posture of the imaging device that captures an image when the pattern and position/posture of the additional object are secondly determined in step S303. Reference numeral 510 denotes a second similarity that represents the similarity of the plurality of images calculated in step S302 and referred to when the pattern and the position/posture of the additional object are secondly determined in step S303.

Reference numeral 511 denotes a third mark indicating the position/posture of the imaging device that captures an image when the pattern and the position/posture of the additional object are thirdly determined in step S303.

As described above, the accuracy of relocalization can be improved by applying the method in the first embodiment.

### Second Embodiment

In the first embodiment, the pattern and the position/posture of an additional object to be added to a field of view (environment) corresponding to a plurality of images acquired by the image acquisition unit 100 are determined based on subjects in the images.

On the other hand, in a second embodiment, patterns of additional objects are determined to be different from each other within the same image group based on a distribution of feature points of a plurality of images. That is, the positions of the additional objects are determined based on a distribution of feature points used to calculate the position/posture of a sensor.

The distribution of the feature points of an image group is calculated using a smallest univalue segment assimilating nucleus (SUSAN) operator for each image.

In addition, the position/posture of an additional object in each image is determined based on the distribution of the feature points of the image group and the number of feature points in each of sections obtained by dividing each image into a predetermined number of sections. Specifically, after a distribution of feature points of each image is calculated, each image is divided into a predetermined number J of sections, and the number of feature points (N11, N12, . . . , NJ) in each partition is calculated.

Then, a section with the smallest total number of feature points (N11+N21+ . . . +NI1, N12+N22+ . . . +NI2, . . . ) in the same section calculated for each of the plurality of images I in the similar image group is calculated. Then, the calculated section is set as a section within an image in the similar image group to which the additional object is to be added.

Thereafter, among a plurality of planes in the section estimated by the Hough transform, the center position of the largest plane (a plane with the largest number of pixels) is set as the position/posture of an object based on coordinates in the image. In the second embodiment, a position where an additional object is to be added is determined in this manner.

The patterns of the additional objects in each image are selected in order from a plurality of system-specific patterns stored in the ROM 202 so that they do not overlap each other within the same similar image group. At this time, similarly to the first embodiment, when there are no patterns that do not overlap each other among the plurality of system-specific patterns stored in the ROM 202, a pattern of an additional object which is processed by rotation and scaling is set as a pattern of an additional object.

### Third Embodiment

In a third embodiment, patterns and positions/postures of objects to be added to a field of view corresponding to a plurality of images acquired by an image acquisition unit 100 are determined independently. In addition, a similarity between images is calculated based on the result, and determination of the pattern and the position/posture of an object is repeated until the similarity between the images is set to be less than a similarity threshold value.

In the third embodiment, the patterns and positions/postures of objects to be added to a field of view corresponding to a plurality of images acquired by the image acquisition unit 100 are determined based on a common region which is a similar local region between the images.

A method of calculating the common region includes detecting a subject shown in each image, and when there is a region similar to the subject in another image, the region is assumed to be a common region. Specifically, an image recognition method using a trained model such as CNN is used to detect a subject shown in an image.

Thereafter, for the detected subject, a pattern matching score using sum of squared difference (SSD) for the other image is calculated.

In addition, when the score is equal to or greater than a subject similarity threshold value read in step S300, the region is determined to be a common region (C1, C2, . . . , CI). When there is no region of which the score is equal to or greater than the subject similarity threshold value, it is determined to be a non-common region (N1, N2, . . . , NI).

When it is determined that an object should be added to the common region, the pattern and the position/posture of the object are determined such that patterns of locations including a common region with the highest subject similarity are different from each other. When it is determined that an object should be added to a non-common region, the pattern and the position/posture of the object are determined such that patterns of locations including a common region with the lowest subject similarity are the same.

At this time, a method of determining the pattern and the position/posture of the object is determined based on position/posture obtained by detecting a subject and information on an additional object associated with the subject, similar to the first embodiment.

Whether an object should be added to a common region or a non-common region is designated by a user through a communication I/O 207 or by system-specific settings stored in a ROM 202, and the pattern and position/posture of the object are determined by the same method as in the first embodiment. Further, in a state where either attribute is limited, only the other attribute is determined.

Note that a map generation unit that generates map information used to calculate the position/posture of an imaging device or the like as a sensor by using an image captured by the imaging device mounted on a moving apparatus may be provided. In addition, a similarity may be calculated using not only the image captured by the imaging device but also distance information or the like acquired by laser imaging detection and ranging (LIDAR), or the above-mentioned map information may be created.

In this case, a similarity calculation unit 101 calculates the similarity of a shape calculated based on distance information, and an additional object determination unit 102 determines the shape and the position/posture of an additional object by the same method as in the first embodiment.

Note that, when the shape and the position/posture of the additional object is determined based on the distance information, a subject list 400 is a list of information regarding the shape. In this case, an additional object list 401 is a list of additional objects associated with a shape, and a pattern list 402 is information regarding the shapes of the additional objects.

Note that the communication I/O 207 can be of any type, such as Ethernet, a USB, serial communication, and wireless communication. Further, in step S300, information is read in a RAM 203 for initialization of the information processing device, but information designated by a user through the communication I/O 207 or system-specific information stored in the ROM 202 may be acquired.

Although a similarity is calculated by applying a method based on bag of words (BOW) in step S302, it is sufficient to calculate a similarity between a plurality of images, a similarity may be calculated using deep learning. Alternatively, a similarity may be calculated based on brightness values or a distribution of feature points of images. Further, a subject similarity may be obtained by calculating a similarity in a local region.

Further, in step S303, it is sufficient to determine the pattern and the position/posture of an additional object so that a similarity R between a plurality of images is set to be less than a similarity threshold value, and thus the pattern and the position/posture may be determined in a random order or in an order designated by a user through the communication I/O 207 instead of being determined in a predetermined order.

Further, an object may be determined such that the similarity R between the plurality of images is set to be less than the similarity threshold value by determining an additional object lacking features. In addition, a plurality of objects may be determined as candidates for additional objects, and an object having the lowest similarity between the images may be determined as the object.

Further, in order to reduce the similarity between the images, an object causing an environmental change, such as lighting equipment that increases an average luminance difference between the images, may be determined to be added. Note that, when lighting equipment is set as an additional object, the additional object may be determined to be added to a position not shown in the image.

In addition, whether to determine an additional object is determined based on a similarity R between a plurality of images, but the determination may be designated by a user through the communication I/O 207, or the determination may be limited to a system-specific value or range stored in the ROM 202.

In addition, when an imaging time difference between images is less than a predetermined time, it may be determined that the addition of an object is unnecessary. That is, this is because there is a possibility that a similarity between a plurality of images will be high when a moving distance of a camera is less than a predetermined distance. Note that the predetermined time may be designated by a user through the communication I/O 207 or may be a system-specific value stored in the ROM 202.

In addition, although the information list of additional objects in FIG. 4 is read at the time of initialization in step S300, it may be read at a timing that can be used in steps S302 and S303. Thus, reading, creating, updating, and the like may be performed as necessary while the information processing device is operated. In addition, the pattern list 402 and the installation method list 403 may be calculated by computation so that the calculation can be performed while operating the information processing device.

In the installation method list 403, the object is installed at a position based on a subject described in the subject list 400, but it is sufficient to perform conversion into the position/posture of the object based on coordinates in the image in step S303. Thus, a position based on coordinates of a field of view (environment) of the camera may be used.

In addition, an image display unit 501 is constituted by two types of image display units, that is, a standard image display unit 502 and a reference image display unit 503, but any configuration for displaying similar images may be used. Thus, the number of types of the image display units is not limited to two. One type or three or more types of images may be displayed.

In addition, it is sufficient that marks 507, 509, and 511 indicating the position/posture of the imaging device are notification methods capable of distinguishing between respective positions/postures. For example, the sizes, colors, patterns, and the like of the marks may be distinguished from each other and displayed in accordance with the magnitude of the similarity R between the plurality of images which is calculated in step S302.

Further, all of the positions/postures of the imaging device that captures images for which it is determined that the similarity R between the plurality of images calculated in step S302 is equal to or greater than the similarity threshold value may be displayed. At this time, it may be limited to a value or range designated by a user through the communication I/O 207 or a system-specific value or range stored in the ROM 202.

Further, in the first embodiment and the second embodiment, patterns and positions/postures of additional objects do not overlap each other in the same image group, but it is sufficient that they are not similar among a plurality of images. Thus, the patterns and positions/postures of the objects may be determined so as not to be similar among all of the images.

Further, in the first embodiment and the third embodiment, an image recognition method using a trained model such as CNN is used to detect a subject, but it is sufficient that an object in an image can be distinguished. Thus, a subject may be estimated from pattern matching using SSD or sum of absolute difference (SAD) using image data and template data.

Instead of detecting an object by a more direct method, a subject may be estimated based on a distribution of feature points in an image. Further, the distribution of the feature points may be calculated by a method using a SUSAN operator or based on a three-dimensional feature amount such as a signature of histograms of orientations (SHOT) feature amount from a plurality of images and feature points.

Further, in the second embodiment, the position/posture of the object is set as the center position of a maximum plane in a section with few feature points, but it does not need to be the center position. The position/posture may be determined to be any one of four corners of a plane or determined randomly. Further, although patterns of additional objects are determined to be different from each other within the same image group, the present invention does not need to be limit to the patterns.

That is, for example, for a section in which a distribution of feature points in each image is sparse, the positions/postures of the objects are determined so as not to overlap each other in the same image group, and thus the objects may be determined such that the positions/postures thereof are different from each other.

Further, the patterns and position/posture of the objects may be determined such that both the attributes of the patterns and the positions/postures are different from each other by combining the above-described method of differentiating positions/postures and method of differentiating patterns.

That is, at least one attribute of patterns, positions, and postures of additional objects to be added to a detection range when a plurality of pieces of detection information having similarities equal to or higher than a predetermined threshold value is detected may be determined to be different from each other. In addition, the patterns and positions/postures may be selectively differentiated. In this case, a user may select determination contents of the additional object determination unit 102.

Further, although similarities of subjects shown in images are calculated in the third embodiment, it does not need to be the subjects, and it is sufficient that distinguishment can be made inside an image in accordance with a certain rule. Thus, a common region between images may be calculated based on a similarity for each section. The section may be designated by a user through the communication I/O 207 or may be set to be a system-specific region stored in the ROM 202, and the similarity for each section may be calculated by the same method as in step S302.

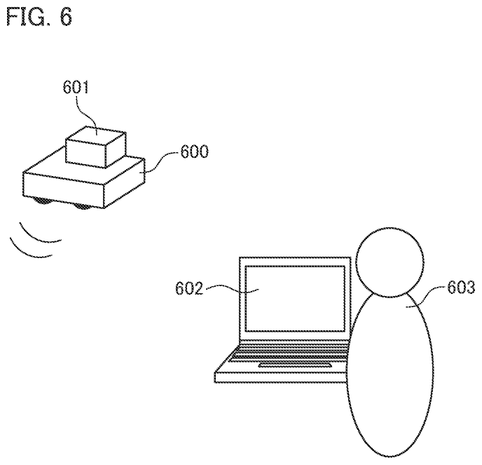

FIG. 6 is a diagram illustrating a configuration of an information processing device in another embodiment. As illustrated in FIG. 6, a configuration may be adopted in which an image captured by an imaging device 601 mounted on a moving apparatus 600 is transmitted to an information processing device (a tablet, a laptop, or the like) separate from the moving apparatus 600, and information on an additional object, and the like are confirmed by a user 603 through a display device 602.

Alternatively, the information processing device may be mounted on the moving apparatus 600, and the display device 602 may be notified of information on an object to be added, and the like through the communication I/O 207.

In addition, an example in which the present invention is applied to an autonomous moving apparatus has been described in the above-described example. However, the moving apparatus in the present embodiment is not limited to autonomous moving apparatus such as an automatic guided vehicle (AGV) and an autonomous mobile robot (AMR). In addition, the moving apparatus may be a moving apparatus used for a driving assistance purpose even when it does not move completely autonomously.

In addition, the moving apparatus may be any mobile device such as an automobile, a train, a ship, an airplane, a robot, a drone, or the like. Further, as described above, at least a portion of the information processing device according to the example may or may not be mounted on the moving apparatus. In addition, the present invention can also be applied when the moving apparatus is remotely controlled.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device through a network or various storage media.

Then, a computer (or a CPU, an MPU, or the like) of the information processing device may be configured to read and execute the program. In such a case, the program and the storage medium storing the program configure the present invention.

This application claims the benefit of Japanese patent application No. 2022-109518, filed on Jul. 7, 2022, which is hereby incorporated by reference herein in its entirety.

What is claimed is:

1. An information processing device comprising:
at least one processor or circuit configured to function as:
a detection information acquisition unit configured to acquire detection information detected by a sensor on a moving apparatus;
a similarity calculation unit configured to calculate similarities of a plurality of pieces of detection information acquired by the detection information acquisition unit at different positions or different orientations;
an additional object determination unit configured to determine positions of additional objects to be added within a detection range of the sensor when the detection information is detected, based on the similarities calculated by the similarity calculation unit; and
a notification unit configured to give a notification of the positions of the additional objects determined by the additional object determination unit.

2. The information processing device according to claim 1, further comprising an imaging unit configured to output an image as the detection information.

3. The information processing device according to claim 1,
wherein the sensor includes a distance measurement unit configured to output distance information as the detection information.

4. The information processing device according to claim 1,
wherein the additional object determination unit determines at least one of postures and patterns of the additional objects.

5. The information processing device according to claim 1,
wherein the additional object determination unit determines the additional objects so that at least one of attributes of the positions, patterns, and postures of the additional objects to be added within the detection range is different from those of the others when a plurality of pieces of detection information having similarities equal to or greater than a predetermined threshold value are detected.

6. The information processing device according to claim 1, wherein the at least one processor or circuit is further configured to function as
a map generation unit configured to generate map information for calculating the position/posture of the sensor based on the detection information.

7. The information processing device according to claim 1,
wherein the additional object determination unit determines the positions of the additional objects based on a distribution of feature points for calculating the position/posture of the sensor.

8. An image processing method comprising:
acquiring detection information output from a sensor on a moving apparatus;
calculating similarities of a plurality of pieces of detection information acquired in the acquiring of the detection information at different positions or orientations;
determining positions of additional objects to be added within a detection range of the sensor when the detection information is detected, based on the similarities calculated in the calculating of the similarities; and
giving a notification of the positions of the additional objects determined in the determining of the positions of the additional objects.

9. A non-transitory computer-readable storage medium storing a computer program including instructions for executing following processes:
acquiring detection information output from a sensor on a moving apparatus;
calculating similarities of a plurality of pieces of detection information acquired in the acquiring of the detection information at different positions or orientations;
determining positions of additional objects to be added within a detection range of the sensor when the detection information is detected, based on the similarities calculated in the calculating of the similarities; and
giving a notification of the positions of the additional objects determined in the determining of the positions of the additional objects.
